(19) United States
(12) Patent Application Publication
(10) Pub. No.: US 2012/0285305 A1
(43) Pub. Date: Nov. 15, 2012

(54) Perfect Cut Saw Guide Systems

(76) Inventor: Robert Jablonsky, Penticton (CA)

(21) Appl. No.: 13/292,301

(22) Filed: Nov. 9, 2011

Related U.S. Application Data
(60) Provisional application No. 61/411,979, filed on Nov. 10, 2010.

(51) Int. Cl. B27B 9/04; B26D 1/18

(52) U.S. Cl. 83/56; 83/745

(57) ABSTRACT

A portable circular saw guide system for use with a portable circular saw. The system may comprise a U-shaped channel track, a saw sled, and a spacer bar. A user may make accurate and straight lengthwise cuts in sheeting material quickly and easily without employing a table saw using the system. The user's own portable circular saw is coupled to the top surface of the saw sled using the sled's two biasing clamps. A spacer bar is used to gauge the distance between the inside flat surface (distal edge) of the saw blade and the channel track for securing the exact position of the portable circular saw on the saw sled. The channel track is clamped parallel to the cut-line and the saw sled placed within the U-shaped channel. The saw is turned on and the saw with the coupled sled is pushed through the channel to make the cut.

### CROSS-REFERENCE TO RELATED APPLICATION

The present application is related to and claims priority from prior provisional application Ser. No. 61/411,979, filed Nov. 10, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of portable circular saws and more specifically relates to portable circular saw guides.

### 2. DESCRIPTION OF THE RELATED ART

In modern residential building construction, the circular saw is the most used tool by home builders. Circular saws may be table mounted (table saw) in which the saw may be placed in a convenient location on the building site, however using these saws require the wood to be cut be brought to the saw. These saws usually have a 110 or 220 volt alternating current (VAC) motor and require a power feed line. Circular saws may be of the portable variety and offer greater versatility than a table saw. These generally have 110 VAC motors as well and are used with an extension cord plugged into a power outlet, but can be carried and used with one hand much of the time. Recently, smaller cordless circular saws with rechargeable batteries have become popular.

The term circular saw is most commonly used to refer to a hand-held electric circular saw designed for cutting wood, but may be used less optimally for cutting other materials with other specialized blades. Circular saws can be either left or right-handed, depending on the side of the blade where the motor sits and which hand the operator uses when holding a saw. What a hand held saw offers in versatility, it lacks in accuracy of cuts. A table saw has a fixed position saw blade and the cutting guide can be adjusted in relation to the blade for the width of piece to be cut, and for making perfectly straight cuts. A portable circular saw is manipulated only by the hand of the user and the quality and accuracy of cut is determined by the user's steadiness of hand and ability to watch the cut-line in relation to the blade. The saw can be easily used on an elevated work deck or roof top for short to moderate length cuts, but long cuts tend to be more erratic.

A table saw is not always available for these cuts on the construction site and so the carpenter's skill must be developed so that wood is not wasted. This tends to be more of a problem for the casual user or the homeowner who gets less practice, on ‘long’ cuts, and where saw cuts must be perfect, such as in making furniture. Conventional guides may be complicated to assemble and use; and are often not versatile enough to be used much of the time being limited in the length of pieces it can cut; or does not rigidly control the saw due to flexing of the guide. A better solution is needed.

Various attempts have been made to solve the above-mentioned problems such as those found in U.S. Pat. Nos. 2006/0027135; 4,335,512; 2,942,633; 2005/0061128; 3,869,951; and 4,751,865. This prior art is representative of portable saw guides. None of the above inventions and patents, taken either singly or in combination, is seen to describe the invention as claimed.

Ideally, a portable circular saw guide should be versatile and provide ease of use, and yet, would operate reliably and be manufactured at a modest expense. Thus, a need exists for a reliable portable circular saw guide system to conveniently make perfect cuts in wood and to avoid the above-mentioned problems.

### BRIEF SUMMARY OF THE INVENTION

In view of the foregoing disadvantages inherent in the known portable circular saw guide art, the present invention provides a novel portable circular saw guide system. The general purpose of the present invention, which will be described subsequently in greater detail is to provide convenience of use to provide straight, reliable, accurate cuts in wood.

The portable circular saw guide system as disclosed herein preferably comprises a channel track, a saw sled comprising a first biasing clamp and a second biasing clamp, and a spacer block. The channel track is removably attachable to a work-piece parallel to a cut-line to provide a straight-edge. The saw sled in preferred embodiments comprises a first biasing clamp and a second biasing clamp and the saw sled is slideably insertable into a U-shaped channel of the channel track. The bottom plate of a portable circular saw may be attached to an upper surface of the saw sled using the first biasing clamp and the second biasing clamp such that a front portion of the bottom plate is clamped under the first biasing clamp and a back portion of the bottom plate is clamped under the second biasing clamp.

A spacer block is removably placable between the blade of the portable circular saw and the channel track to align the blade of the portable circular saw with the cut-line (to maintain a uniform cut displacement.) When the portable circular saw guide system is clamped onto a work-piece and a portable circular saw positioned properly beneath the biasing clamps of the saw sled with the saw sled placed into the track, it is usable to cut a straight line on the work-piece. The channel track preferably comprises extruded aluminum and is about 4 feet in length and about 5¼ inches in width but may be about 10 feet in length and about 5¼ inches in width. Some embodiments may contain two (or more) sizes within a kit.

The channel track may comprise two vertical sides about ½ inch in height each and may comprise plate metal about ⅛ of an inch in thickness. The saw sled may further comprise a rectangular shape about 14 inches in length, by about ½ inch in height, and about 5¼ inches in width. The saw sled may be constructed of wood or may be constructed of plastic (or other suitable material) and may have an adhesively attached non-slip surface on its top side. The spacer block (for determining proper position of the portable circular saw in the biasing clamps of the saw sled) may comprise a rectangular cross-section with a proximate edge and a distal edge or may comprise a square cross-section depending on the brand of portable circular saw used. The spacer block may also comprise wood or may comprise plastic in different embodiments. The channel track underside surface may comprise an adhesively attached non-slip material to prevent the channel track from sliding on the work-piece to be cut.

The portable circular saw guide system may comprise a kit having: a channel track; a saw sled; a spacer block; and a set of user instructions.

A method of use is also described herein for a portable circular saw guide system and may comprise the steps of: placing a saw sled into a coupled relationship with a portable circular saw; positioning the saw sled into a channel track; clamping the portable circular saw onto the saw sled using a first biasing clamp and a second biasing clamp; clamping the channel track to a work piece parallel to a proposed cut-line; slideably cutting a work-piece along the proposed cut-line; and removing the portable circular saw guide system from the work-piece.

The present invention holds significant improvements and serves as a portable circular saw guide system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, perfect cut saw guide systems, constructed and operative according to the teachings of the present invention.

FIG. 1 shows a perspective view illustrating an in-use condition of a portable circular saw guide system according to an embodiment of the present invention.

FIG. 2 is a perspective view illustrating various separate components of the portable circular saw guide system according to an embodiment of the present invention of FIG. 1.

FIG. 3 is a perspective view illustrating the portable circular saw guide system according to an embodiment of the present invention of FIG. 1.

FIG. 4 is a frontal view illustrating the portable circular saw guide system according to an embodiment of the present invention of FIG. 1.

FIG. 5 is a flowchart illustrating a method of use of the portable circular saw guide system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a circular saw device and more particularly to a portable circular saw guide system as used to provide convenience of use and quality of cuts in wood.

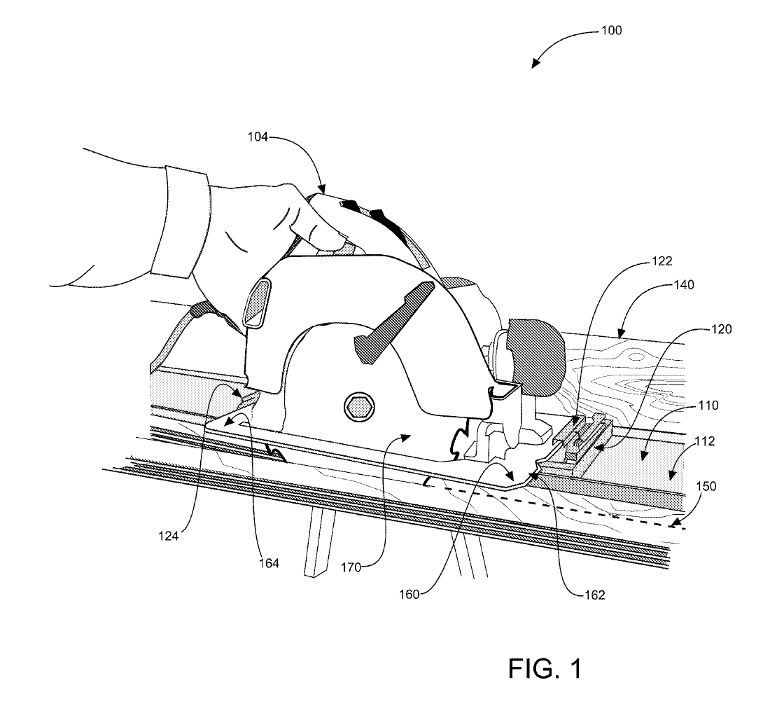

Referring to the drawings by numerals of reference there is shown in FIG. 1, a perspective view illustrating an in-use condition of portable circular saw guide system 100 according to an embodiment of the present invention.

Portable circular saw guide system 100 of the present invention is designed to facilitate accurate and straight cuts as individuals use portable circular saw 104. Portable circular saw guide system 100 may comprise: channel track 110; saw sled 120 comprising first biasing clamp 122 and second biasing clamp 124; and spacer block 130. Channel track 110 is removably attachable to work-piece 140 parallel to cut-line 150.

Saw sled 120 comprises (in preferred embodiments) first biasing clamp 122 and second biasing clamp 124 and in alternate embodiments may comprise other suitable coupling means. Bottom plate 160 of portable circular saw 104 may be attached to upper surface 126 of saw sled 120 using first biasing clamp 122 and second biasing clamp 124 such that front portion 162 of bottom plate 160 is clamped under first biasing clamp 122, and back portion 164 of bottom plate 160 is clamped under second biasing clamp 124. Saw sled 120 is slideably inserted into U-shaped channel 112 of channel track 110 such that it may slide along U-shaped channel 112 during at least one cutting procedure. Spacer block 130 is removably placed between saw blade 170 of portable circular saw 104 and channel track 110 to align saw blade 170 of portable circular saw 104 with cut-line 150. Portable circular saw guide system 100 is usable to cut a straight line on work-piece 140 such as plywood or other wooden sheeting material.

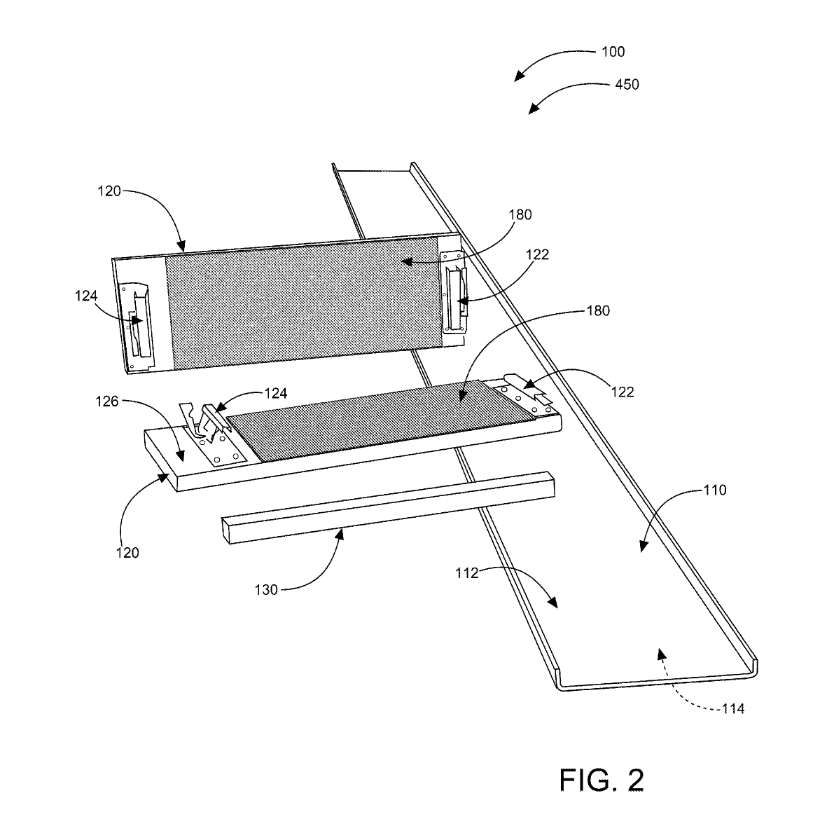

Referring now to FIG. 2, a perspective view illustrating the separate components of portable circular saw guide system 100 according to an embodiment of the present invention of FIG. 1. Channel track 110 preferably comprises extruded aluminum but may comprise a ferrous, nonferrous, or non-metal material construction and may be about 4 feet in length, and about 5¼ inches in width. It is desirable that channel track 110 comprise durable material that doesn't readily bend or flex. Channel track 110 may comprise about 10 feet in length and about 5¼ inches in width and have two vertical sides each about ½ inch in height. Saw sled 120 may comprise a rectangular shape about 14 inches in length and about ½ inch in height and about 5¼ inches in width and be constructed of wood or plastic. Saw sled 120 upper surface 126 may comprise non-slip material 180 which is adhesively attached to prevent portable circular saw 104 from sliding once locked into position on saw sled 120. Channel track 110 may comprise plate metal about ⅛ inch in thickness and have a smooth surface inside U-shaped channel 112 to allow an easy slide movement of saw sled 120. Upon reading this specification, it should be appreciated that, under appropriate circumstances, considering such issues as user preferences, design preference, structural requirements, marketing preferences, cost, available materials, technological advances, etc., other design arrangements such as, for example, larger or smaller channel tracks or saw sleds of varying size and shape, etc., may be sufficient.

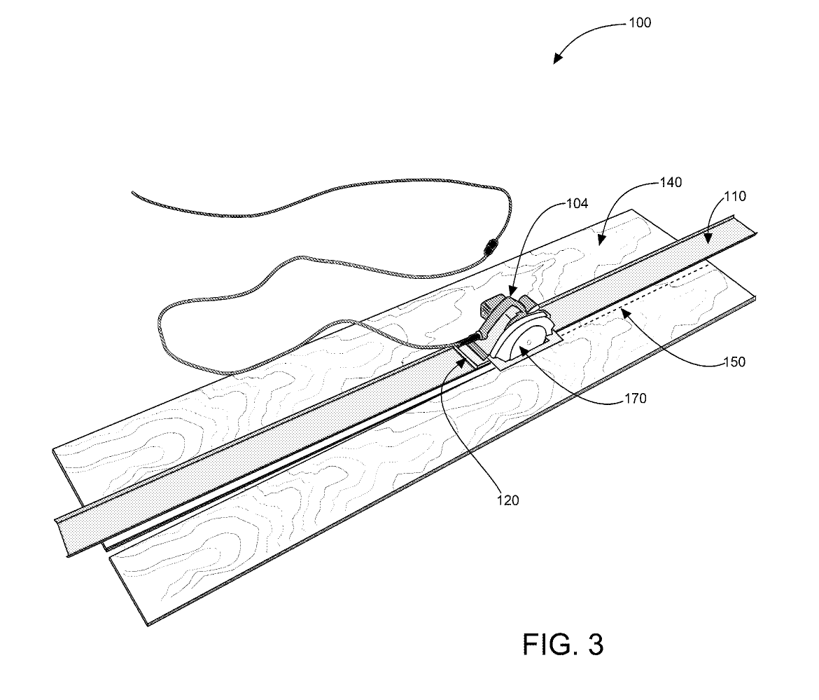

Referring now to FIG. 3, a perspective view illustrating portable circular saw guide system 100 according to an embodiment of the present invention of FIG. 1. A user may place channel track 110 on the materials to be cut and then place saw sled 120 and spacer block 130 at the edge of a table. The desired portable circular saw 104 can then be placed onto saw sled 120 with saw blade 170 touching spacer block 130. Portable circular saw 104 can then be ‘locked’ to saw sled 120 and saw sled 120 placed in channel track 110 and then pushed down channel track 110 while making the cut. Channel track 110 underside surface 114 may comprise non-slip material 180 which may be adhesively attached to prevent movement of channel track 110, and saw blade 170 in relation to cut-line 150, when clamped to wood or other material intended to be cut.

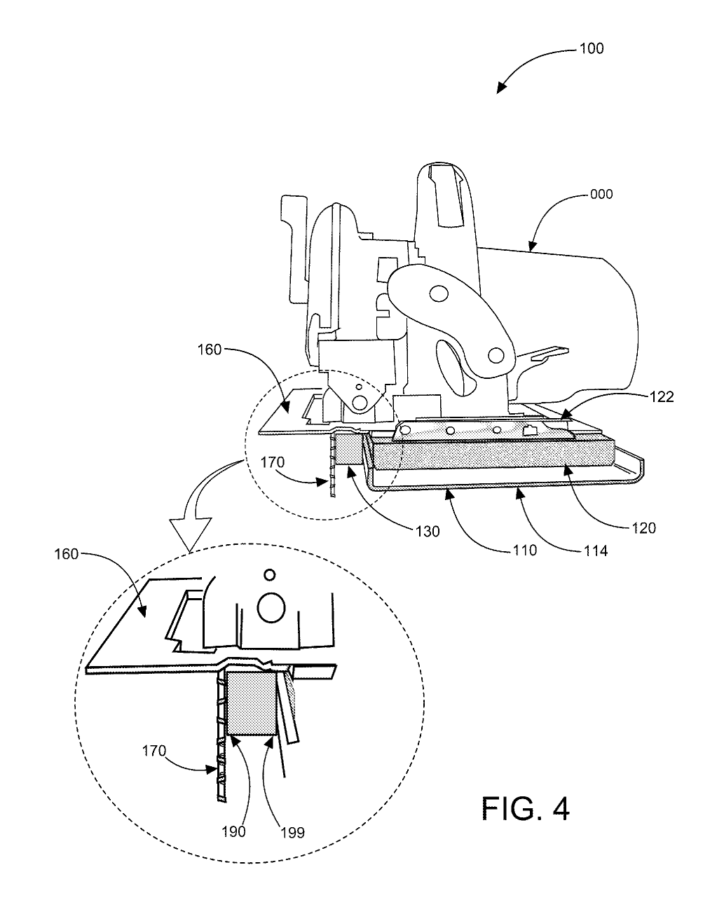

Referring now to FIG. 4, is a frontal view illustrating portable circular saw guide system 100 according to an embodiment of the present invention of FIG. 1. Spacer block 130 for positioning saw blade 170, is designed to be placed between saw sled 120 and saw blade 170 prior to use of portable circular saw 104. Spacer block 130 can be made of plastic or wood and may be a similar length to saw sled 120.

To use the device, saw sled 120 and spacer block 130 can be placed on a flat table with the long edge of spacer block 130 hanging over the edge of the table about ⅛ of an inch. Portable circular saw 104 may then be placed on saw sled 120 between first biasing clamp 122 and second biasing clamp 124, with the edge of saw blade 170 making light contact with spacer block 130. First biasing clamp 122 and second biasing clamp 124 can be locked to bottom plate 160, and spacer block 130 can be removed. Channel track 110 may be set on work-piece 140 to be cut, and portable circular saw 104 with attached saw sled 120 can be set into channel track 110. The user can start portable circular saw 104 and push portable circular saw 104 and saw sled 120 down channel track 110 to create a perfectly straight cut. Spacer block 130 may comprise a rectangular cross-section with proximate edge 190 and distal edge 199 but may comprise a square cross-section depending on particular brand of portable circular saw 104 used. Spacer block 130 preferably comprises plastic but may comprise wood or another suitable material in other embodiments, as mentioned previously.

Portable circular saw guide system 100 according to an embodiment of the present invention of FIGS. 1-4, may be sold as kit 450 comprising the following parts: at least one channel track 110; at least one saw sled 120; at least one spacer block 130; and at least one set of user instructions. Portable circular saw guide system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

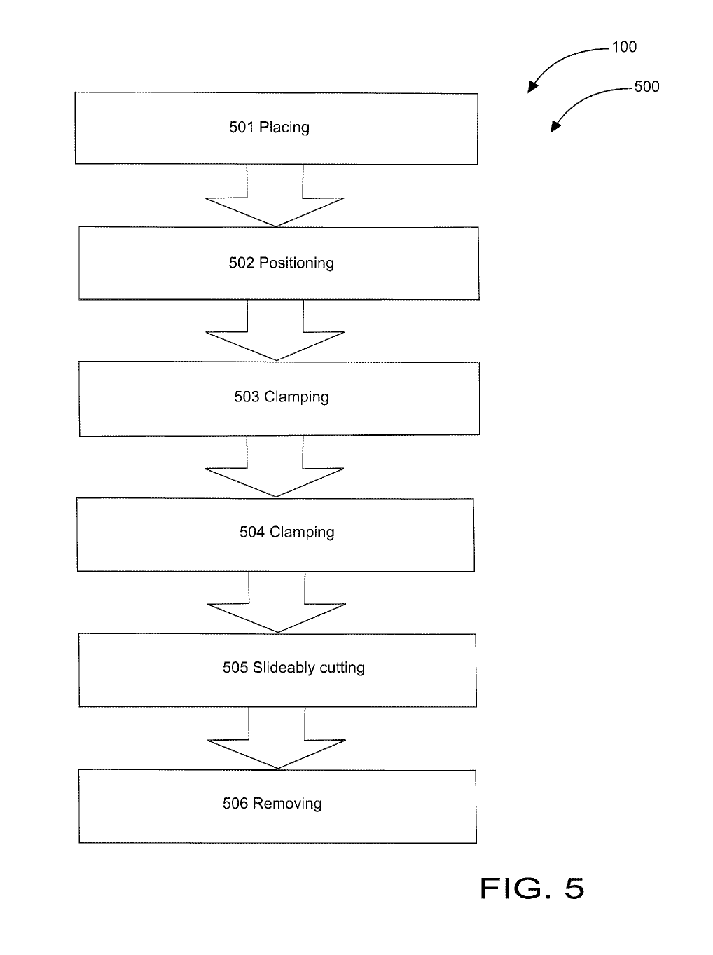

Referring now to FIG. 5, showing a flowchart illustrating method of use 500 for portable circular saw guide system 100 according to an embodiment of the present invention of FIGS. 1-4. Method of use 500 for portable circular saw guide system 100 may comprise the steps of: step one 501 placing saw sled 120 into a coupled relationship with portable circular saw 104; step two 502 positioning saw sled 120 into channel track 110; step three 503 clamping portable circular saw 104 onto saw sled 120 using first biasing clamp 122 and second biasing clamp 124 (or other suitable equivalent coupling means); step four 504 clamping channel track 110 to work-piece 140 parallel to proposed cut-line 150; step five 505 slideably cutting work-piece 140 along proposed cut-line 150; and step six 506 removing portable circular saw guide system 100 from work-piece 140.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable circular saw guide system comprising:
a channel track;
a saw sled comprising:
a first biasing clamp; and
a second biasing clamp; and
a spacer block;
wherein said channel track is removably attachable to a work-piece parallel to a cut-line;
wherein said saw sled comprising said first biasing clamp and said second biasing clamp is slideably inserted into a U-shaped channel of said channel track;
wherein a bottom plate of a portable circular saw is attached to an upper surface of said saw sled using said first biasing clamp and said second biasing clamp such that a front portion of said bottom plate is clamped under said first biasing clamp and a back portion of said bottom plate is clamped under said second biasing clamp;
wherein said spacer block is removably placed between a blade of said portable circular saw and said channel track to align said blade of said portable circular saw with said cut-line; and
wherein said portable circular saw guide system is usable to cut a straight line on said work-piece.

2. The portable circular saw guide system of claim 1 wherein said channel track comprises extruded aluminum.

3. The portable circular saw guide system of claim 2 wherein said channel track comprises about 4 feet in length and about 5¼ inches in width.

4. The portable circular saw guide system of claim 2 wherein said channel track comprises about 10 feet in length and about 5¼ inches in width.

5. The portable circular saw guide system of claim 1 wherein said channel track comprises two vertical sides each about ½ inches in height.

6. The portable circular saw guide system of claim 1 wherein said saw sled further comprises a rectangular shape about 14 inches in length and about ½ inch in height and about 5¼ inches in width.

7. The portable circular saw guide system of claim 6 wherein said saw sled comprises wood.

8. The portable circular saw guide system of claim 6 wherein said saw sled comprises plastic.

9. The portable circular saw guide system of claim 1 wherein said saw sled upper surface comprises a non-slip material.

10. The portable circular saw guide system of claim 9 wherein said non-slip material on said saw sled upper surface is adhesively attached.

11. The portable circular saw guide system of claim 1 wherein said spacer block comprises a rectangular cross-section with a proximate edge and a distal edge.

12. The portable circular saw guide system of claim 11 wherein said spacer block comprises a square cross-section.

13. The portable circular saw guide system of claim 12 wherein said spacer block comprises wood.

14. The portable circular saw guide system of claim 12 wherein said spacer block comprises plastic.

15. The portable circular saw guide system of claim 1 wherein said channel track underside surface comprises a non-slip material.

16. The portable circular saw guide system of claim 15 wherein said non-slip material of said channel track underside surface is adhesively attached.

17. The portable circular saw guide system of claim 2 wherein said channel track comprises plate metal about ⅛ inch in thickness.

18. A portable circular saw guide system comprising:
a channel track;
a saw sled comprising:
a first biasing clamp; and
a second biasing clamp; and
a spacer block;
wherein said channel track is removably attachable to a work-piece parallel to a cut-line;
wherein said saw sled comprising said first biasing clamp and said second biasing clamp is slideably inserted into a U-shaped channel of said channel track;
wherein a bottom plate of a portable circular saw is attached to an upper surface of said saw sled using said first biasing clamp and said second biasing clamp such that a front portion of said bottom plate is clamped under said first biasing clamp and a back portion of said bottom plate is clamped under said second biasing clamp;
wherein said spacer block is removably placed between a blade of said portable circular saw and said channel track to align said blade of said portable circular saw with said cut-line; and
wherein said portable circular saw guide system is usable to cut a straight line on said work-piece;
wherein said channel track comprises extruded aluminum;
wherein said channel track comprises about 4 feet in length and about 5¼ inches in width;
wherein said channel track comprises about 10 feet in length and about 5¼ inches in width;
wherein said channel track comprises two vertical sides each about ½ inches in height;
wherein said channel track comprises plate metal about ⅛ inch in thickness;
wherein said saw sled comprises a rectangular shape about 14 inches in length and about ½ inch in height and about 5¼ inches in width;
wherein said saw sled comprises wood;
wherein said saw sled upper surface comprises a non-slip material;
wherein said non-slip material on said saw sled upper surface is adhesively attached;
wherein said spacer block comprises a rectangular cross-section with a proximate edge and a distal edge;
wherein said spacer block comprises a square cross-section;
wherein said spacer block comprises wood;
wherein said channel track underside surface comprises a non-slip material;
wherein said non-slip material of said channel track underside surface is adhesively attached; and
wherein said portable circular saw guide system is usable to cut a straight line on said work-piece.

19. The portable circular saw guide system of claim 18 comprising a kit having:
said channel track;
said saw sled;
said spacer block; and
a set of user instructions.

20. A method of use for a portable circular saw guide system comprising the steps of:
placing a saw sled into a coupled relationship with a portable circular saw;
positioning said saw sled into a channel track;
clamping said portable circular saw onto said saw sled using a first biasing clamp and a second biasing clamp;
clamping said channel track to said work piece parallel to a proposed cut-line;
slideably cutting a work-piece along said proposed cut-line; and
removing said portable circular saw guide system from said work-piece.
